(19) United States
(12) Patent Application Publication
(10) Pub. No.: US 2005/0118502 A1
(43) Pub. Date: Jun. 2, 2005

(54) Energy device and method for producing the same

(75) Inventors: Kazuyoshi Honda, Takatsuki-shi (JP); Kiichiro Oishi, Kyoto-shi (JP); Yasuhiko Bito, Minamikawachi-gun (JP); Takayuki Nakamoto, Sakai-shi (JP)

Correspondence Address: MERCHANT & GOULD PC, P.O. BOX 2903, MINNEAPOLIS, MN, 55402-0903, US

(73) Assignee: Matsushita Electric Industrial Co., Ltd., Kadoma-shi (JP)

(21) Appl. No.: 10/979,637

(22) Filed: Nov. 1, 2004

(30) Foreign Application Priority Data
Nov. 27, 2003 (JP) 2003-397567

(51) Int. Cl. H01M 4/58; H01M 4/66; H01M 4/04

(52) U.S. Cl. 429/218.1; 429/245; 29/623.5

(57) ABSTRACT

A negative active material thin film containing silicon as a main component is formed on a collector. A composition gradient layer, in which a composition distribution of a main component element of the collector and silicon is varied smoothly, is formed in the vicinity of the interface between the collector and the negative active material thin film. The composition gradient layer contains at least one kind of third element selected from W, Mo, Cr, Co, Fe, Mn, Ni, and P, in addition to the elements contained in the collector and the elements contained in the negative active material thin film. The third element irregularizes the atomic arrangement at the interface between the collector and the negative active material thin film. Therefore, even when the negative active material absorbs/desorbs ions during charging/discharging, thereby allowing silicon particles in the negative active material to expand/contract, the strain at the interface involved in the expansion/contraction of the silicon particles is alleviated, and peeling at the interface between the negative active material thin film and the collector is suppressed. Consequently, cycle characteristics are enhanced.

### BACKGROUND OF THE INVENTION

1. Field of the Invention

The present invention relates to an energy device and a method for producing the same.

2. Description of the Related Art

A lithium ion secondary battery includes a negative collector, a negative active material, an electrolyte, a separator, a positive active material, and a positive collector as main components. The lithium ion secondary battery plays a major role as an energy source for mobile communication equipment and various kinds of AV equipment. Along with the miniaturization and the enhanced performance of equipment, the miniaturization and the increase in energy density of the lithium ion secondary battery are proceeding. Thus, significant efforts are being put into improving each element constituting the battery.

For example, JP8(1996)-78002A discloses that an energy density can be increased by using, as a positive active material, an amorphous oxide obtained by melting mixed powder of a particular transition metal oxide with heating, followed by rapid cooling.

Furthermore, JP2000-12092A discloses that a battery capacity and a cycle life can be enhanced by using a transition metal oxide containing lithium as a positive active material, using a compound containing silicon atoms as a negative active material, and setting the weight of the positive active material to be larger than that of the negative active material.

Furthermore, JP2002-83594A discloses that an amorphous silicon thin film is used as a negative active material. Due to the use of the amorphous silicon thin film, a larger amount of lithium can be absorbed compared with the case of using carbon, so that an increase in capacity is expected.

JP2001-266851A describes the following. In forming a negative active material on a negative collector, the negative active material is formed at such a temperature that a mixed layer, in which a negative collector component diffuses, is formed in the negative active material in the vicinity of an interface between the negative collector and the negative active material. Due to the mixed layer, the adhesion between the negative collector and the negative active material becomes satisfactory, whereby an electrode for a lithium ion secondary battery having a high charging/discharging capacity and excellent charging/discharging cycle characteristics is obtained.

In an energy device, the enhancement of a battery capacity and cycle characteristics is a particularly important object; however, it may not be considered that the above-mentioned conventional techniques have achieved the object sufficiently.

The cycle characteristics are largely influenced by the adhesion strength at the interface between the collector and the active material. In JP2001-266851A, although the adhesion strength is enhanced by forming a mixed layer at the interface, it is necessary to control the temperature during formation of the negative active material, which causes an industrial constraint.

Thus, the chemical approach for realizing excellent cycle characteristics still is not sufficient, and there is a demand for the establishment of a high-performance silicon negative electrode.

### SUMMARY OF THE INVENTION

The object of the present invention is to provide an energy device with satisfactory cycle characteristics and a method for producing the same by a simple procedure.

In order to achieve the above-mentioned object, an energy device of the present invention includes a negative active material thin film, containing silicon as a main component, formed on a collector. A composition gradient layer, in which a composition distribution of a main component element of the collector and silicon is varied smoothly, is formed in the vicinity of an interface between the collector and the negative active material thin film containing silicon as a main component. The composition gradient layer contains at least one kind of third element selected from W, Mo, Cr, Co, Fe, Mn, Ni, and P, in addition to elements contained in the collector and elements contained in the negative active material thin film.

Furthermore, a method for producing an energy device of the present invention includes forming a negative active material thin film, containing silicon as a main component, on a collector by a vacuum film-forming process. With respect to a negative active material film-forming source for forming the negative active material thin film and an auxiliary film-forming source containing a third element, which is not contained in the collector and the negative active material film-forming source, and a main component element of the collector, placed adjacent to each other so that parts of film-forming particles from the respective sources are mixed with each other, the collector is moved relatively from the auxiliary film-forming source side to the negative active material film-forming source side.

These and other advantages of the present invention will become apparent to those skilled in the art upon reading and understanding the following detailed description with reference to the accompanying figures.

### BRIEF DESCRIPTION OF THE DRAWINGS

FIG. 1 is a cross-sectional view showing a schematic configuration of one embodiment of an apparatus used for producing an energy device of the present invention.

FIG. 2 is an element distribution diagram in a thickness direction of a negative active material thin film of Example 1 of the present invention.

FIG. 3 is an element distribution diagram in a thickness direction of a negative active material thin film of Example 2 of the present invention.

### DESCRIPTION OF THE PREFERRED EMBODIMENTS

According to the energy device and the method for producing the same of the present invention, an energy device with satisfactory cycle characteristics can be obtained.

The energy device of the present invention includes a collector and a negative active material thin film containing silicon as a main component formed on the collector. In the vicinity of the interface between the collector and the negative active material thin film containing silicon as a main component, a composition gradient layer is formed in which a composition distribution of a main component element of the collector and silicon is varied smoothly. The composition gradient layer contains at least one kind of third element selected from W, Mo, Cr, Co, Fe, Mn, Ni, and P, in addition to the elements contained in the collector and the elements contained in the negative active material thin film.

According to the present invention, “containing silicon as a main component” means that the content of silicon is 50 at % or more. The content of silicon is desirably 70 at % or more, more desirably 80 at % or more, and most desirably 90 at % or more. As the content of silicon in the negative active material thin film is higher, the battery capacity can be increased more.

Furthermore, the “main component element of a collector” refers to an element contained in the collector in an amount of 50 at % or more.

The third element that is not contained in either of the collector and the negative active material thin film irregularizes the atomic arrangement at the interface between the collector and the negative active material thin film. Thus, even when the negative active material absorbs/desorbs ions during charging/discharging, thereby allowing silicon particles in the negative active material to expand/contract, the interface at which the atomic arrangement is irregularized alleviates the strain involved in the expansion/contraction of the silicon particles. Therefore, peeling at the interface between the negative active material thin film and the collector can be suppressed. Furthermore, a composition distribution of the main component element of the collector and silicon is varied smoothly in the vicinity of the interface, whereby the strain caused by the expansion/contraction of the silicon particles can be distributed. In this manner, the adhesion strength at the interface between the negative active material thin film and the collector is enhanced, and consequently, the cycle characteristics of an energy device are enhanced.

The third element is at least one kind selected from W, Mo, Cr, Co, Fe, Mn, Ni, and P. Any of these elements have a great effect of irregularizing the atomic arrangement at the interface between the collector and the negative active material thin film. Therefore, these elements can enhance the cycle characteristics of an energy device.

It is preferable that the collector contains copper as a main component. According to this configuration, an energy device can be produced easily at a low cost. Herein, “containing copper as a main component” means that the content of copper is 50 at % or more. The content of copper is desirably 70 at % or more, more desirably 80 at % or more, and most desirably 90 at % or more.

It may be preferable that a part of the silicon contained in the negative active material thin film is an oxide. The oxide of silicon as used herein does not include an oxide of silicon contained in boundary portions between the negative active material thin film and the other layers. This means that an oxide of silicon is contained in an intermediate region excluding upper and lower boundary portions of the negative active material thin film in a thickness direction. In the case where a content of silicon in the negative active material thin film is large, and a battery capacity is large, the degree of expansion/contraction of silicon particles during charging/discharging is high, which may degrade cycle characteristics. When the negative active material thin film contains an oxide of silicon, since the oxide of silicon expands/contracts less during charging/discharging, the expansion/contraction of the silicon particles during charging/discharging can be suppressed, and the cycle characteristics can be enhanced.

Furthermore, according to a method for producing an energy device of the present invention, a negative active material thin film containing silicon as a main component is formed on a collector by a vacuum film-forming process. With respect to a negative active material film-forming source for forming the negative active material thin film and an auxiliary film-forming source containing a third element, which is not contained in the collector and the negative active material film-forming source, and a main component element of the collector, placed adjacent to each other so that parts of film-forming particles from the respective sources are mixed with each other, the collector is moved relatively from the auxiliary film-forming source side to the negative active material film-forming source side.

Thus, by performing continuous mixed film-formation using two film-forming sources, a composition gradient layer, in which a composition distribution of the main component element of the collector and silicon constituting the negative active material is varied smoothly, is formed at the interface between the negative active material thin film and the collector. Furthermore, the third element irregularizes the atomic arrangement of the composition gradient layer. Thus, even when the negative active material absorbs/desorbs ions during charging/discharging, thereby allowing silicon particles in the negative active material to expand/contract, since the composition gradient layer alleviates the strain involved in the expansion/contraction of the silicon particles, peeling at the interface between the negative active material thin film and the collector can be suppressed. In this manner, the adhesion strength at the interface between the negative active material thin film and the collector is enhanced, so that an energy device with cycle characteristics enhanced can be provided.

The composition gradient layer in the vicinity of the interface between the negative active material thin film and the collector, in which a composition distribution of the main component element of the collector and silicon is varied smoothly, is formed by the above-mentioned continuous mixed film-formation. When a third layer is merely inserted between the negative active material thin film and the collector, boundaries with a discontinuous composition are formed between the third layer and the negative active material thin film and between the third layer and the collector, and the force caused by the strain due to the expansion/contraction of silicon particles is concentrated at the boundaries, which makes it impossible to obtain satisfactory cycle characteristics.

As described above, JP2001-266851A describes the following. In formation of a negative active material on a negative collector, the negative active material is formed at such a temperature that a mixed layer in which a negative collector component diffuses is formed in the negative active material in the vicinity of an interface between the negative collector and the negative active material. In this case, the substrate temperature condition is limited to a high temperature, and it is necessary to control a temperature strictly. In contrast, according to the method for producing an energy device of the present invention, the negative active material thin film only needs to be formed by continuous mixed film-formation, resulting in satisfactory productivity.

It is preferable that the third element is at least one selected from W, Mo, Cr, Co, Fe, Mn, Ni, and P. Any of these elements have a great effect of irregularizing the atomic arrangement at the interface between the collector and the negative active material thin film. Therefore, these elements can enhance the cycle characteristics of an energy device.

According to the above-mentioned production method, the “vacuum film-forming process” includes various kinds of vacuum thin film production processes such as vapor deposition, sputtering, chemical vapor deposition (CVD), ion plating, laser abrasion, and the like. Depending upon the kind of a thin film, an appropriate film-forming process can be selected. A thinner negative active material thin film can be produced more efficiently by a vacuum film-forming process. As a result, a small and thin energy device is obtained. Furthermore, the “film-forming particles” refer to particles, such as atoms, molecules, or a cluster, which are released from film-forming sources in these vacuum film-forming processes, and adhere to a film-formation surface to form a thin film.

According to the above-mentioned production method, it is preferable that the vacuum film-forming process is vacuum vapor deposition. According to this configuration, a negative active material thin film of high quality can be formed stably and efficiently.

Furthermore, according to the above-mentioned production method, the “main component element of a collector” refers to an element contained in the collector in an amount of 50 at % or more.

It is preferable that the main component element of the collector is copper. According to this configuration, an energy device can be produced easily at a low cost.

Hereinafter, an embodiment of the present invention will be described with reference to the drawings.

### Embodiment 1

An energy device according to Embodiment 1 of the present invention will be described.

The energy device of Embodiment 1 has the following configuration. A cylindrical winding body, in which a positive collector with a positive active material formed on both surfaces thereof, a separator, and a negative collector with a negative active material formed on both surfaces thereof are wound so that the separator is placed between the positive collector and the negative collector, is placed in a battery can, and the battery can is filled with an electrolyte solution.

As the positive collector, a foil, a net, or the like (thickness: 10 to 80 μm) made of Al, Cu, Ni, or stainless steel can be used. Alternatively, a polymer substrate made of polyethylene terephthalate, polyethylene naphthalate, or the like, with a metal thin film formed thereon, also can be used.

The positive active material is required to allow lithium ions to enter therein or exit therefrom, and can be made of a lithium-containing transition metal oxide containing transition metal such as Co, Ni, Mo, Ti, Mn, V, or the like, or a mixed paste in which the lithium-containing transition metal oxide is mixed with a conductive aid such as acetylene black and a binder such as nitrile rubber, butyl rubber, polytetrafluoroethylene, polyvinylidene fluoride, or the like.

As the negative collector, a foil, a net, or the like (thickness: 10 to 80 μm) made of Cu, Ni, or stainless steel can be used. Alternatively, a polymer substrate made of polyethylene terephthalate, polyethylene naphthalate, or the like, with a metal thin film formed thereon, also can be used.

The separator preferably has excellent mechanical strength and ionic permeability, and can be made of polyethylene, polypropylene, polyvinylidene fluoride, or the like. The pore diameter of the separator is, for example, 0.01 to 10 μm, and the thickness thereof is, for example, 5 to 200 μm.

As the electrolyte solution, a solution, which is obtained by dissolving an electrolyte salt such as LiPF₆, LiBF₄, LiClO₄, or the like in a solvent such as ethylene carbonate, propylene carbonate, methyl ethyl carbonate, methyl acetate hexafluoride, tetrahydrofuran, or the like, can be used.

As the battery can, although a metal material such as stainless steel, iron, aluminum, nickel-plated steel, or the like can be used, a plastic material also can be used depending upon the use of a battery.

The negative active material is a silicon thin film containing silicon as a main component. The silicon thin film preferably is amorphous or microcrystalline, and can be formed by a vacuum film-forming process such as sputtering, vapor deposition, or CVD.

### EXAMPLES 1-2, AND COMPARATIVE EXAMPLE 1

Examples corresponding to Embodiment 1 will be described.

First, a method for producing a positive electrode will be described. Li₂CO₃ and CoCO₃ were mixed in a predetermined molar ratio, and synthesized by heating at 900° C. in the air, whereby LiCoO₂ was obtained. LiCoO₂ was classified to 100-mesh or less to obtain a positive active material. Then, 100 g of the positive active material, 12 g of carbon powder as a conductive agent, 10 g of polyethylene tetrafluoride dispersion as a binder, and pure water were mixed to obtain a paste. The paste containing the positive active material was applied to both surfaces of a band-shaped aluminum foil (thickness: 25 μm) as a positive collector, followed by drying, whereby a positive electrode was obtained.

Using a band-shaped copper foil (thickness: 30 μm) as a negative collector, a silicon thin film was formed as a negative active material on both surfaces of the copper foil by vacuum vapor deposition. This will be described in detail later.

As a separator, band-shaped porous polyethylene (thickness: 35 μm) with a width larger than those of the positive collector and the negative collector was used.

A positive lead made of the same material as that of the positive collector was attached to the positive collector by spot welding. Furthermore, a negative lead made of the same material as that of the negative collector was attached to the negative collector by spot welding.

The positive electrode, the negative electrode, and the separator obtained as described above were laminated so that the separator was placed between the positive electrode and the negative electrode, and wound in a spiral shape. An insulating plate made of polypropylene was provided to upper and lower surfaces of the cylindrical winding body thus obtained, and the resultant cylindrical winding body was placed in a bottomed cylindrical battery can. A stepped portion was formed in the vicinity of an opening of the battery can. Thereafter, as a non-aqueous electrolyte solution, an isosteric mixed solution of ethylene carbonate and diethyl carbonate, in which LiPF₆ was dissolved in a concentration of 1×10³ mol/m³, was injected into the battery can, and the opening was sealed with a sealing plate to obtain a lithium ion secondary battery.

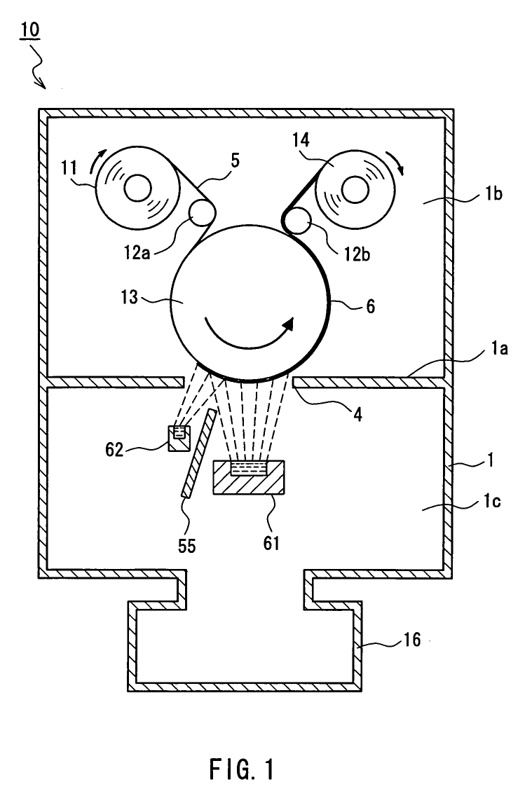

A method for forming a silicon thin film as the negative active material will be described with reference to FIG. 1.

A vacuum film-forming apparatus 10 shown in FIG. 1 includes a vacuum tank 1 partitioned into an upper portion and a lower portion by a partition wall 1a. In a chamber (transportation chamber) 1b on an upper side of the partition wall 1a, an unwinding roll 11, a cylindrical can roll 13, a take-up roll 14, and transportation rolls 12a, 12b are placed. In a chamber (thin film forming chamber) 1c on a lower side of the partition wall 1a, an electron beam vapor deposition source 61, an auxiliary electron beam vapor deposition source 62, and a mobile shielding plate 55 are placed. At a center of the partition wall 1a, a mask 4 is provided, and a lower surface of the can roll 13 is exposed to the thin film forming chamber 1c side via the opening of the mask 4. The inside of the vacuum tank 1 is maintained at a predetermined vacuum degree by a vacuum pump 16.

A band-shaped negative collector 5 unwound from the unwinding roll 11 is transported successively by the transportation roll 12a, the can roll 13, and the transportation roll 12b, and taken up around the take-up roll 14. During this process, particles (film-forming particles; hereinafter, referred to as “evaporated particles”) such as atoms, molecules, or a cluster generated from the auxiliary electron beam vapor deposition source 62 and the electron beam vapor deposition source 61 pass through the mask 4 of the partition wall 1a, and adhere to the surface of the negative collector 5 running on the can roll 13, thereby forming a thin film 6. The auxiliary electron beam vapor deposition source 62, the mobile shielding plate 55, and the electron beam vapor deposition source 61 are placed so as to be opposed to the negative collector 5 from an upstream side to a downstream side in the transportation direction of the negative collector 5. The mobile shielding plate 55 can move in a radius direction with respect to a rotation central axis of the can roll 13. The distance of the mobile shielding plate 55 from an outer circumferential surface of the can roll 13 was adjusted so that a part of evaporated particles from the auxiliary electron beam vapor deposition source 62 and a part of evaporated particles from the electron beam vapor deposition source 61 are mixed with each other in the vicinity of the outer circumferential surface of the can roll 13. Accordingly, first, the evaporated particles from the auxiliary electron beam vapor deposition source 62 mainly are deposited on the surface of the negative collector 5; thereafter, the ratio of the evaporated particles from the electron beam vapor deposition source 61 is increased gradually; and finally, the evaporated particles from the electron beam vapor deposition source 61 mainly are deposited.

In Example 1, using the above-mentioned apparatus, silicon was deposited by electron beam vapor deposition from the electron beam vapor deposition source 61, whereby a silicon thin film (thickness: 8 μm) was formed on a copper foil as the negative collector 5. The deposition rate of the silicon thin film was set to be about 0.15 μm/s. Simultaneously, copper-chromium containing copper as a main component was evaporated from the auxiliary electron beam vapor deposition source 62. The deposition amount of copper-chromium from the auxiliary electron beam vapor deposition source 62 was set to be the same as that for vapor-depositing only copper-chromium to form a thin film having a thickness of 50 nm.

In Example 2, a negative active material was formed in the same way as in Example 1, except that copper-nickel containing copper as a main component was evaporated from the auxiliary electron beam vapor deposition source 62. The deposition amount of copper-nickel by the auxiliary electron beam vapor deposition source 62 was set to be the same as that for vapor-depositing only copper-nickel to form a thin film having a thickness of 2 μm.

In Comparative Example 1, a negative active material was formed in the same way as in Example 1, except that the auxiliary electron beam vapor deposition source 62 was not used.

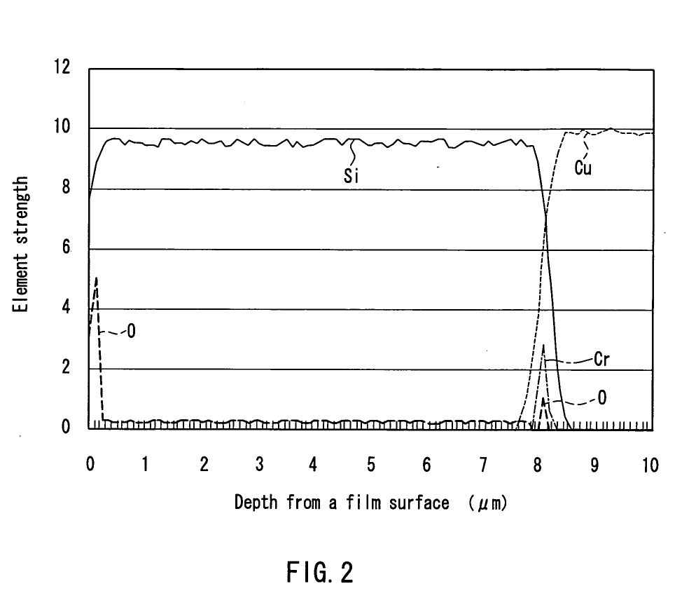

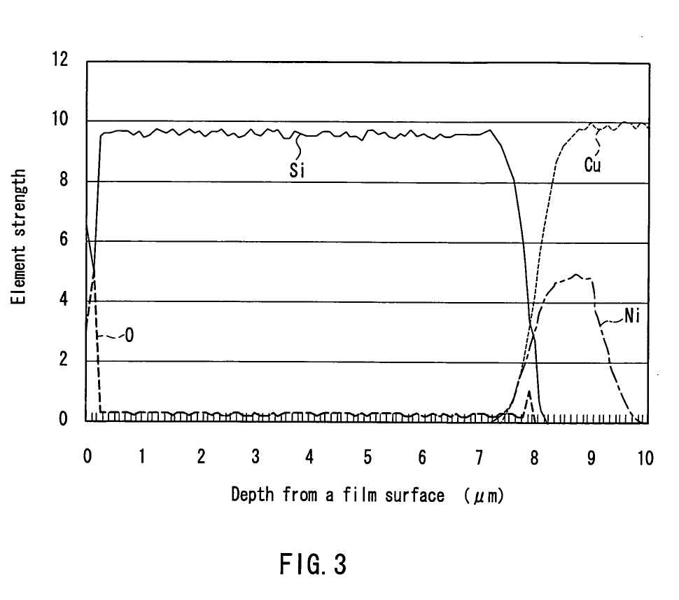

FIGS. 2 and 3 show Auger depth profiles of the silicon thin films (negative active material thin films) of Examples 1 and 2. The Auger depth profile was measured with SAM 670 produced by Philips Co., Ltd. The Auger depth profile was measured at an acceleration voltage of an electron gun of 10 kV, an irradiation current of 10 nA, an acceleration voltage of an ion gun for etching of 3 kV, and a sputtering rate of 0.17 nm/s. “Depth from a film surface” represented by the horizontal axis in FIGS. 2 and 3 was obtained by converting the sputter etching time of a sample into an etching depth in a thickness direction, using a sputtering rate obtained by measuring the level difference formed by sputter-etching the same Si film and Cu film as those of the sample with a level difference measuring apparatus.

As is understood from FIGS. 2 and 3, in Examples 1 and 2 (FIGS. 2 and 3), in an initial stage of forming a negative active material thin film, by performing continuous mixed film-formation using two film-forming sources, a composition gradient layer, in which silicon and a main component element (copper) of a negative collector are mixed, and a composition distribution of these elements is varied smoothly, is formed at the interface between the negative collector and the negative active material. Furthermore, a third element (chromium in Example 1; nickel in Example 2) not contained in either of the negative collector and the negative active material is vapor-deposited together with the main component element of the negative collector from the auxiliary electron beam vapor deposition source 62, so that the third element is mixed in the composition gradient layer.

The lithium ion secondary batteries formed in Examples 1 and 2, and Comparative Example 1 were subjected to a charging/discharging cycle test at a test temperature of 20° C., a charging/discharging current of 3 mA/cm², and a charging/discharging voltage range of 4.2 V to 2.5 V. The ratios of the discharging capacity after 50 cycles and 200 cycles, with respect to the initial discharging capacity, were obtained as battery capacity maintenance ratios (cycle characteristics). Table 1 shows the results.

TABLE 1

| | Example 1 | Example 2 | Comparative Example 1 |
|---|---|---|---|
| After 50 cycles | 92% | 94% | 76% |
| After 200 cycles | 82% | 86% | 42% |

As is understood from Table 1, in Examples 1 and 2 in which the composition gradient layer with a smooth variation in composition, containing a third element (chromium in Example 1; nickel in Example 2) not contained in any of the negative collector and the negative active material, is formed at the interface between the negative collector and the negative active material, the battery capacity maintenance ratios after 50 cycles and 200 cycles can be set to be larger than those in Comparative Example 1 in which a composition is varied abruptly at the interface, and a composition gradient layer is not formed substantially.

In Example 1, in the case where the deposition amount of copper-chromium was set to be less than 10 nm at a thickness conversion value (chemically quantified average thickness) when only copper-chromium was vapor-deposited, the enhancement degree of cycle characteristics was decreased to about 30% of Example 1. Thus, it is preferable that the deposition amount of copper-chromium is 50 nm or more at a thickness conversion value (chemically quantified average thickness) when only copper-chromium was vapor-deposited.

On the other hand, in Example 2, in the case where the deposition amount of copper-nickel exceeds 10 μm at a thickness conversion value (chemically quantified average thickness) when only copper-nickel was vapor-deposited, the decrease in productivity and the abnormal growth of vapor-deposited particles were conspicuous. Thus, it is preferable that the deposition amount of copper-nickel is 10 μm or less at a thickness conversion value (chemically quantified average thickness) when only copper-nickel is vapor-deposited.

Although copper-chromium and copper-nickel were evaporated from the auxiliary electron beam vapor deposition source 62 in Examples 1 and 2, it was confirmed that, even in the case of using W, Mo, Co, Fe, Mn, or P in place of chromium or nickel, cycle characteristics are enhanced. The reason why the cycle characteristics are enhanced when these third elements are contained at the interface between the negative collector and the negative active material is not clarified sufficiently. However, the following reason may be considered: the atomic arrangement is irregularized due to the presence of the third element having a different property such as a different atomic radius, and this conveniently alleviates the strain energy caused by the expansion/contraction of a negative active material due to the absorption/desorption of lithium by the negative active material.

An auxiliary sputtering film-forming source also can be used in place of the auxiliary electron beam vapor deposition source 62.

As described above, when a negative active material containing silicon as a main component is formed on a negative collector by a vacuum film-forming process, a film-formation surface of the negative collector is moved relatively from a first region where the main component element particles of the negative collector and the third element particles are deposited to a second region where silicon particles are deposited. Furthermore, in order to gradually vary the concentration of elements of particles to be deposited, a part of the first region is overlapped with a part of the second region, whereby a region (mixed film-formation region) is provided in which the main component element particles of the negative collector and the third element particles are mixed with silicon particles, followed by being deposited. Because of this, a composition gradient layer, which contains a third element and in which a composition distribution of a main component element of the negative collector and silicon is varied smoothly, is formed at an interface between the negative collector and the negative active material. The composition gradient layer smoothly varies the physical characteristics at the interface between the negative collector and the negative active material, and the third element irregularizes the atomic arrangement in the composition gradient layer. Therefore, even when silicon particles in the negative active material expand/contract during charging/discharging, the composition gradient layer alleviates the strain involved in the expansion/contraction of the silicon particles. Thus, the adhesion strength between the negative collector and the negative active material is enhanced, and consequently, cycle characteristics are enhanced as in Examples 1 and 2.

In the above-mentioned Examples 1 and 2, the negative active material is formed by vapor deposition. However, the present invention is not limited thereto. Other vacuum film-forming processes such as sputtering and CVD may be used, and even in this case, the similar effects can be obtained.

The copper foil used as the negative collector in Examples 1 and 2 may be subjected to surface treatment. As the surface treatment that can be used for the copper foil, zinc plating; alloy plating of zinc and tin, copper, nickel or cobalt; formation of a covering layer using an azole derivative such as benzotriazole; formation of a chromium-containing coating film using a solution containing chromic acid or dichromate; or a combination thereof can be used. Alternatively, in place of a copper foil, another substrate provided with a copper covering may be used. The above-mentioned surface treatment may be performed with respect to the surface of the copper covering.

The content of the third element contained in the composition gradient layer will be described. Energy devices were produced with the content being varied with respect to W, Mo, Cr, Co, Fe, Mn, Ni, and P as the third element, followed by being evaluated, whereby each preferable content was obtained. The content of the third element in the thin film was obtained by integrating the intensity of a signal of an Auger depth profile with respect to a formed thin film, in a depth direction. The thickness of the thin film only made of the third element formed so as to have the same value as an integral value of the intensity of a signal was set to be a film thickness corresponding to the content of a third element (hereinafter, referred to as a “corresponding film thickness”). When the corresponding film thickness was too small, the effect of adding the third element was not obtained. This limit value was set to be a lower limit corresponding film thickness. When the corresponding film thickness was too large, the effect of adding the third element was saturated and moreover, the harmful influences such as the increase in an inner resistance and the roughness of a surface, the decrease in productivity, and the like were conspicuous. This limit value was set to be an upper limit corresponding film thickness. The lower limit corresponding film thickness and the upper limit corresponding film thickness are varied depending upon the kind of the third element. Table 2 shows the lower limit corresponding film thickness and the upper limit corresponding film thickness of each third element.

TABLE 2

| | Lower limit | Upper limit |
|---|---|---|
| | corresponding film | corresponding film |
| | thickness (nm) | thickness (nm) |
| W | 12 | 500 |
| Mo | 12 | 500 |
| Cr | 15 | 900 |
| Co | 20 | 1200 |
| Fe | 20 | 1000 |
| Mn | 30 | 800 |
| Ni | 20 | 2000 |
| P | 40 | 500 |

Although not mentioned in the description of the above-mentioned embodiment and examples, it is desirable that a negative active material thin film is formed in the atmosphere of inert gas or nitrogen. An atmospheric gas may be introduced toward a film-formation surface (the opening of the mask 4 in the above-mentioned examples). Alternatively, the atmospheric gas may be introduced so as to spread throughout the entire vacuum tank (the thin film forming chamber 1c in the above-mentioned examples). In terms of efficiency, it is preferable that the atmospheric gas is introduced toward the film-formation surface.

By forming a negative active material thin film in such an atmospheric gas, silicon columnar particles adjacent to each other in a direction parallel to the film-formation surface can be prevented from being integrated and growing to enlarge the particle diameter of silicon. Consequently, the degradation of the cycle characteristics due to the extreme expansion/contraction of silicon particles during charging/discharging can be suppressed. According to the experiment by the inventors of the present invention, although a graph showing detailed experimental results is omitted, by forming a negative active material thin film in the above-mentioned gas atmosphere, the number of charging/discharging cycles for decreasing the battery capacity maintenance ratio of the energy device to 80% was increased, for example, by 15 to 50%.

The preferable introduction amount of gas is set in accordance with the film-formation condition of the negative active material thin film, particularly, in accordance with the thin film deposition rate R (nm/s). For example, in the case of introducing gas toward the film-formation surface, a gas introduction amount Q (m³/s) per film-formation width of 100 mm is preferably in a range of 1×10⁻¹⁰×R to 1×10⁻⁶×R, and more preferably in a range of 1×10⁻⁹×R to 1×10⁻⁷×R. When the gas introduction amount is too small, the above-mentioned effects cannot be obtained. In contrast, when the gas introduction amount is too large, the deposition rate of the negative active material thin film is decreased.

As the gas to be used, argon is most preferable in terms of practicality and conspicuousness of the above-mentioned effects.

Furthermore, it may be preferable that a part of silicon contained in the negative active material thin film is an oxide. In the case where the content of silicon in the negative active material thin film is large, and the battery capacity is large, the degree of expansion/contraction of the silicon particles during charging/discharging may be increased, and cycle characteristics may be degraded. When the negative active material thin film contains an oxide of silicon, since the oxide of silicon expands/contracts less during charging/discharging, the expansion/contraction of the silicon particles during charging/discharging can be suppressed, and cycle characteristics can be enhanced. For example, it is preferable that the negative active material thin film is formed so that 20 to 50% of silicon contained in the negative active material thin film becomes an oxide. According to the experiment by the inventors of the present invention, although a graph showing detailed experimental results is omitted, by allowing the negative active material thin film to contain an oxide of silicon, the number of charging/discharging cycles for decreasing the battery capacity maintenance ratio of the energy device to 80% was increased, for example, by 10 to 140% (which depends upon the negative active material thin film).

A part of silicon can be formed into an oxide, for example, by introducing oxygen-based gas in the vicinity of the film-formation surface, and allowing the gas to react with silicon atoms during formation of the negative active material thin film in a vacuum atmosphere. In order to enhance reactivity, it is effective to use ozone, and provide energy by plasma, a substrate potential, or the like.

The preferable introduction amount of gas is set in accordance with the film-formation condition of the negative active material thin film, particularly, in accordance with the thin film deposition rate R (nm/s). For example, in the case where gas is introduced toward a film-formation surface, a gas introduction amount P(m³/s) per film-formation width of 100 mm is preferably in a range of 1×10⁻¹¹×R to 1×10⁻⁵×R, more preferably in a range of 1×10⁻¹⁰×R to 1×10⁻⁶×R, and most preferably in a range of 1×10⁻⁹×R to 1×10⁻⁷×R. It should be noted that the gas introduction amount P is not limited to the above, depending upon the facility form and the like. When the gas introduction amount is too small, the above-mentioned effects cannot be obtained. In contrast, when the gas introduction amount is too large, the entire negative active material thin film becomes an oxide, which decreases a battery capacity.

The applicable field of the energy device of the present invention is not particularly limited. For example, the energy device can be used as a secondary battery for thin and lightweight portable equipment of a small size.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

1. An energy device comprising a negative active material thin film, containing silicon as a main component, formed on a collector,
wherein a composition gradient layer, in which a composition distribution of a main component element of the collector and silicon is varied smoothly, is formed in the vicinity of an interface between the collector and the negative active material thin film containing silicon as a main component, and
the composition gradient layer contains at least one kind of third element selected from W, Mo, Cr, Co, Fe, Mn, Ni, and P, in addition to elements contained in the collector and elements contained in the negative active material thin film.

2. The energy device according to claim 1, wherein the collector contains copper as a main component.

3. The energy device according to claim 1, wherein a part of silicon contained in the negative active material thin film is an oxide.

4. A method for producing an energy device comprising forming a negative active material thin film, containing silicon as a main component, on a collector by a vacuum film-forming process,
wherein, with respect to a negative active material film-forming source for forming the negative active material thin film and an auxiliary film-forming source containing a third element, which is not contained in the collector and the negative active material film-forming source, and a main component element of the collector, placed adjacent to each other so that parts of film-forming particles from the respective sources are mixed with each other, the collector is moved relatively from the auxiliary film-forming source side to the negative active material film-forming source side.

5. The method for producing an energy device according to claim 4, wherein the third element is at least one selected from W, Mo, Cr, Co, Fe, Mn, Ni, and P.

6. The method for producing an energy device according to claim 4, wherein the vacuum film-forming process is vacuum vapor deposition.

7. The method for producing an energy device according to claim 4, wherein the main component element of the collector is copper.
